(19) United States
(12) Patent Application Publication
(10) Pub. No.: US 2009/0006464 A1
(43) Pub. Date: Jan. 1, 2009

(54) Offender transport tracking and emergency response (OTTER) system

(76) Inventors: Lynn D. Churchill, Missoula, MT (US); Charles Eubank, JR., Missoula, MT (US)

Correspondence Address: R. Stephen Hansell;Lawyer, Patent Attorney, & Construction Arbitrator, 5240 Lower Martin Lane, Florence, MT, 59833-6817, US

(21) Appl. No.: 11/823,494

(22) Filed: Jun. 29, 2007

(51) Int. Cl. G06F 17/30

(52) U.S. Cl. 707/103 R

(57) ABSTRACT

A computer based process which allows communication between third party systems capable of text based notification via the Internet and any Common Alert Protocol (CAP) enabled alerting system by analyzing data in e-mail alerts and matching that data with a list of Offender Tracking, Transport, and Emergency Response (“OTTER”)-defined response plans. When appropriate, OTTER processes the data and converts the data into a format that can be sent to a CAP enabled alerting system. Once relayed to the alerting system, alerting occurs across a broad range of communications devices including e-mail, cellular and land-based phones, Personal Data Assistants, SMS text messaging, etc. This allows for a unified approach to managing alerts from multiple monitoring and alerting systems in an organization.

### REFERENCES CITED

| Number | Date | Inventor |
|---|---|---|
| 6,014,080 | 11 Jan. 2000 | Layson, Jr. |
| 6,535,582 | 18 Mar. 2003 | Harris |
| 6,774,799 | 10 Aug. 2004 | Defant, et al. |
| 7,085,359 | 1 Aug. 2006 | Crites, et al. |
| 7,119,695 | 10 Oct. 2006 | Defant, et al. |
| 7,123,141 | 17 Oct. 2006 | Contestabile |

### BACKGROUND OF THE INVENTION

1. Field of Invention

The present invention relates to a computer based process for tracking offenders whose movements are restricted by Court Order or legal process, and for tracking motor vehicles, truck fleets, aircraft and other civil applications. More particularly, the present invention relates to a computer and GIS-based system which serves as a link between several systems and processes which do not communicate with each other and enables these various and varied systems and processes to generate a generic alert through the CHAIN alerting system.

2. Description of Prior Art

Because of the diverse technology and lack of standardization of tracking and alerting systems, without the present invention tracking is limited to e-mail alerts. Service providers such as iSECUREtrac™, Air-Trak™, and Elmo-Tech™ monitor infractions of defined business rules by means of electronic bracelets, home-based and motor vehicle-based radio transmitters, and equivalent technologies, and forward alerts or messages by various means to a base server unit which conveys the information to public or private security entities for appropriate response. CHAIN provides consistent and standardized reporting, but many of the monitoring programs do not report infractions in a format recognized by CHAIN.

### SUMMARY OF THE INVENTION

OTTER, the acronym for the present invention, greatly expands the number and type of communication media to cell phones, land lines, alpha pagers, numeric pagers, fax, and SMS. The present invention provides an improved, effective, and efficient method for expanding the available means of communication. The present invention provides a means to translate any data matching any OTTER response plan criteria, sorted from most specific to least specific, to a CHAIN-compatible format. OTTER contacts the CHAIN server and relays the new stream of information recognizable to CHAIN, and CHAIN generates notifications over the required media channels. While OTTER presently uses e-mail as its primary source of event data, the system has been designed to work with multiple input formats including direct contact via World Wide Web service and by active monitoring of vendor data via Web service.

### BRIEF DESCRIPTION OF THE DRAWINGS

FIG. 1 is a schematic of the OTTER Portal Architecture.

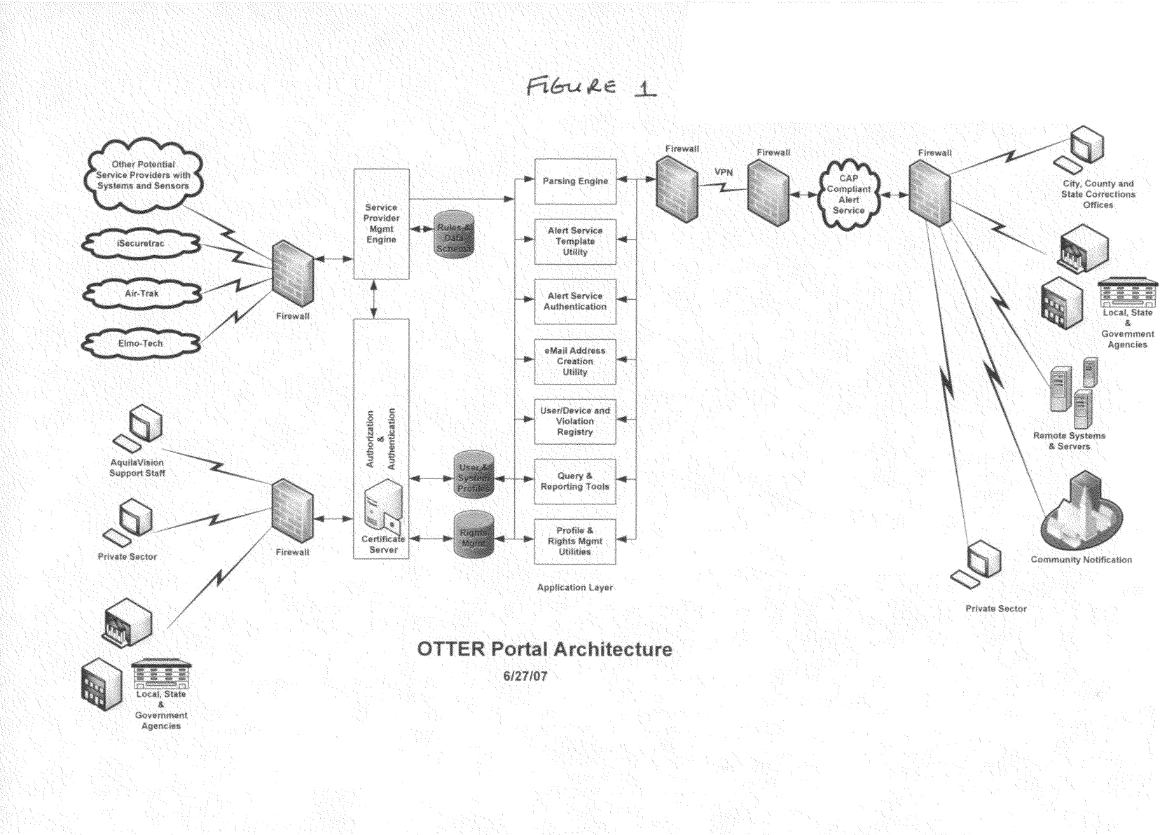

### DETAILED DESCRIPTION OF THE INVENTION

The present invention involves a process for linking different offender tracking technologies. Whenever a new client is added to the OTTER family, a new processing layer is added to support that client, thereby expanding OTTER's functionality and scope. Essential data are compared with response plans predefined in OTTER for that client. An iSECUREtrak™ response plan might look for an offender named “Bob Smith” and an associated infraction of “Inclusion Zone Violation”. An e-mail alert from Air-Trak™ might contain a reference to vehicle ID “75632” with a related offense of “Speed Limit Exceeded”.

Several response plans can be defined for a single e-mail address. The scope of the criteria may be as broad as “any offender” and “any infraction”, or as narrow as one specific offender and a specific infraction. If the data from the e-mail matches any of the OTTER response plan criteria (sorted from most specific to least specific), the information is then manipulated into a new format which is compatible with CHAIN. OTTER then contacts the CHAIN server, relaying this new stream of information. CHAIN, able to process these data, generates notifications over the required media channels. While OTTER currently uses e-mail as its primary source of event data, the system has been designed to work with multiple input formats including direct contact via web service (pushed by client) and by active monitoring of vendor data via web service (pulled from client).

I claim:

1. A computer and GIS based system comprising hardware and software for interpreting various input data and transmitting the information represented by the data to CHAIN, which then reports infractions of defined business rules to clients for appropriate response.

2. The computer system described in claim 1 above, wherein the source code for the software is as indicated in Attachment A, OTTER Stored Procedures.
